(19) United States
(12) Patent Application Publication
(10) Pub. No.: US 2023/0333523 A1
(43) Pub. Date: Oct. 19, 2023

(54) Systems and Methods for Auxiliary Advising and Manufacturing Control

(71) Applicant: The Regents of the University of California, Oakland, CA (US)

(72) Inventors: Guann-Pyng LI, Irvine, CA (US); Yutian REN, Irvine, CA (US)

(73) Assignee: The Regents of the University of California, Oakland, CA (US)

(21) Appl. No.: 18/300,855

(22) Filed: Apr. 14, 2023

Related U.S. Application Data
(60) Provisional application No. 63/330,933, filed on Apr. 14, 2022.

(51) Int. Cl. G05B 13/02; G05B 13/04

(52) U.S. Cl. CPC G05B 13/028; G05B 13/042

(57) ABSTRACT

Process and device configurations are provided operating and designing an auxiliary advisory system for manufacturing control systems and machine operations. Systems and processes are configured to utilize adaptive learning and context awareness to provide auxiliary advising and to assess a manufacturing environment and infrastructure. Processes are provided to receive and process data for a machine operation and assess interactions relative to one or more of a worker, machine, machine component and material. The processes and systems may output advice to assist with existing manufacturing systems and to adapt to changes in manufacturing conditions and environmental constraints. Advisory system functions may also include anomaly detection and recognition of worker gestures to control operation of a machine and a manufacturing process. Processes are provided to integrate causal relationships of objects by self-labeling data into causality models for assessing machine operation.

### CROSS REFERENCE TO RELATED APPLICATION

This application claims priority to U.S. provisional application No. 63/330,933 titled SYSTEMS AND METHODS FOR AUXILIARY ADVISING AND MANUFACTURING CONTROL filed on Apr. 14, 2022, the content of which is expressly incorporated by reference in its entirety.

### STATEMENT OF GOVERNMENT SUPPORT

This invention was made with Government support under Grant No. DE-EE00076143 awarded by the U.S. Department of Energy Clean Energy Smart Manufacturing Innovation Institute (CESMII). The Government has certain rights in the invention.

### FIELD

The present disclosure generally relates to auxiliary advising for machine control, and devices, methods and systems for an auxiliary advisor tool for situation and context awareness of manufacturing. Embodiments provide energy productivity improvement in manufacturing and methods for creating, refining and using datasets for machine and manufacturing control.

### BACKGROUND

Manufacturing systems and processes can rely on a combination of machines and workers for various tasks. Manufacturing tasks can span a range of complexity and involvement with workers. Defined operations for these systems can vary even when a uniform process is adopted across different manufacturing lines. Whether automated, manual, or a combination, various manufacturing systems may be difficult to assess, even with data generated by manufacturing sensors and control systems. In addition, there may be variables outside the detection range of manufacturing sensors that may influence or impact manufacturing efficiency, energy use and yield. There exists a need for systems and methods to provide assessments of manufacturing operations.

Existing manufacturing control systems can provide monitoring and control of manufacturing processes but lack the view of outside-in information and context-awareness. For example, US20200166909A1 describes methods of data generation for machine learning models. U.S. Ser. No. 10/394,229B2 describes a plant advisory system and machine learning models. U.S. Ser. No. 11/017,271B2 describes an adaptive machine learning system for object recognition. There exists a need for an auxiliary advisory tool to capture outside-in information, especially for existing manufacturing systems, to enable the adaption of manufacturing processes and the adaptation of the detection models (such as machine learning models) residing in the advisory tool.

There also exists a need for methods of contextualizing information associated with machine and manufacturing operations. Systems and processes are needed to determine contextual connections between machine operations and to allow for improved monitoring and control of machine and manufacturing operations.

### BRIEF SUMMARY OF THE EMBODIMENTS

Disclosed and described herein are systems, methods and configurations for auxiliary advising. In one embodiment, an auxiliary advising system to monitor machine operation includes a first sensor configured to detect a state of a first object of the machine operation, and a second sensor configured to detect a state of a second object of the machine operation. The system also includes a controller coupled to the first sensor and the second sensor. The controller is configured to receive the state of the first object and the state of the second object, and assess the machine operation using a causality model for at least one of the first object and second object, wherein the causality model includes a labeled dataset for machine operation, The controller is also configured to output a machine operation determination including at least one of a context adaptation output, interaction context detection output and anomaly prevention output.

According to embodiments, the first sensor and the second sensor detect operations of the first object and the second object, wherein the state of the first object and the state of the second object are each finite states of a finite state machine model for the machine operation.

According to embodiments, the first sensor is a camera sensor and the second sensor detects power usage of at least one component of the machine operation.

According to embodiments, the causality model of the machine operation is determined using a model for each of the first object and the second object, and wherein the labeled dataset identifies interactions of objects and sensor output.

According to embodiments, the causality model provides a model for interactions between the first object and the second object, wherein the causality model includes at least one data segment labeled based on a causal state transition for at least one of the first object and second object.

According to embodiments, machine operation is assessed using a trained dataset for interactions between the first object and the second object, the trained dataset generated for the machine operation by mapping sensed data to standard operating procedure of at least one machine component.

According to embodiments, the context adaptation output provides a determination for sensed data compared to historical data for the machine operation to include at least one of an alert of a data shift, deviation from data pattern and change in environmental condition.

According to embodiments, the interaction context detection output provides a determination of at least one causal interaction between the first object and second object and a determination of a source of an interaction.

According to embodiments, the anomaly prevention output labels at least a portion of collected data for the machine operation as an anomaly.

According to embodiments, outputting a machine operation determination includes annotating sensor data of a first object to include a label in response to detection of a state transition in at least one data segment for the second object.

Another embodiment is directed to a method for operation of an auxiliary advising system to monitor machine operation. The method includes receiving, by a controller, output from a first sensor configured to detect a state of a first object of the machine operation, and output from a second sensor configured to detect a state of a second object of the machine operation. The method also includes assessing, by the controller, the machine operation using a causality model for at least one of the first object and second object, wherein the causality model includes a labeled dataset for machine operation. The method also includes outputting, by the controller, a machine operation determination including at least one of a context adaptation output, interaction context detection output and anomaly prevention output.

According to embodiments, the first sensor and the second sensor detect operations of the first object and the second object, wherein the state of the first object and the state of the second object are each finite states of a finite state machine model for the machine operation.

According to embodiments, the first sensor is a camera sensor and the second sensor detects power usage of at least one component of the machine operation.

According to embodiments, the causality model of the machine operation is determined using a model for each of the first object and the second object, and wherein the labeled dataset identifies interactions of objects and sensor output.

According to embodiments, the causality model provides a model for interactions between the first object and the second object, wherein the causality model includes at least one data segment labeled based on a causal state transition for at least one of the first object and second object.

According to embodiments, machine operation is assessed using a trained dataset for interactions between the first object and the second object, the trained dataset generated for the machine operation by mapping sensed data to standard operating procedure and at least one machine component.

According to embodiments, the context adaptation output provides a determination for sensed data compared to historical data for the machine operation to include at least one of an alert of a data shift, deviation from data pattern and change in environmental condition.

According to embodiments, the interaction context detection output provides a determination of at least one causal interaction between the first object and second object and a determination of a source of an interaction.

According to embodiments, wherein the anomaly prevention output labels at least a portion of collected data for the machine operation as an anomaly.

According to embodiments, outputting a machine operation determination includes annotating sensor data of a first object to include a label in response to detection of a state transition in at least one data segment for the second object.

Another embodiment is directed to a method for labeled datasets for operation of an auxiliary advising system to monitor machine operation. The method includes receiving, by a controller, a plurality of defined first object states and a plurality of defined second object states. The method also includes receiving, by a controller, domain data for the first object and the second object, the domain data including a standard operating procedure for the first object and the second object in a machine operation. The method also includes determining, by the controller, a causality model for the first object and the second object, wherein the causality model maps detected object states to at least one causal state. The method also includes labeling, by a controller, at least one data segment of sensor data for at least one of the first object and second object, and generating, by the controller, the causality model for a machine operation to include evaluations for at least one of context adaptation, interaction context detection and anomaly prevention.

According to embodiments, the first object is one of a machine, worker and material, and the machine operation includes at least one interaction between the first object and the second object.

According to embodiments, the causality model of the machine operation is determined using a model for each of the first object and the second object, and wherein labeling data identifies interactions of objects and sensor output.

According to embodiments, labeling at least one data segment of sensor data includes identifying at least one state transition for an object, selection of the at least one data segment based on a temporal relationship of the at least one state transition, and annotating the at least one data segment with a label.

According to embodiments, labeling at least one data segment of sensor data for at least one of the first object and the second object includes identifying a time interval between a state transition for the first object and a state transition for the second object, and annotating at least one segment of data of an identified state transition with information identifying the state transition.

According to embodiments, the context adaptation provides a determination for sensed data compared to historical data for the machine operation to include at least one of an alert of a data shift, deviation from data pattern and change in environmental condition.

According to embodiments, the interaction context detection provides a determination of at least one causal interaction between the first object and second object and a determination of a source of an interaction.

According to embodiments, the anomaly prevention labels at least a portion of collected data for the machine operation as an anomaly.

According to embodiments, the causality model provides a model for interactions between the first object and the second object, wherein the causality model includes at least one data segment labeled based on a causal state transition for at least one of the first object and second object.

According to embodiments, the method also includes representing a standard operating procedure as a dynamic knowledge graph showing state transitions and corresponding time intervals, and extracting at least one temporal causal relationship from the dynamic knowledge graph to build the causality model.

Other aspects, features, and techniques will be apparent to one skilled in the relevant art in view of the following detailed description of the embodiments.

### BRIEF DESCRIPTION OF THE DRAWINGS

The application file contains at least one drawing executed in color. Copies of this patent or patent application publication with color drawing(s) will be provided by the Office upon request and payment of the necessary fee.

The features, objects, and advantages of the present disclosure will become more apparent from the detailed description set forth below when taken in conjunction with the drawings in which like reference characters identify correspondingly throughout and wherein:

FIG. 1 is a graphical representation of an auxiliary advising system to monitor machine operation according to one or more embodiments;

FIG. 2A illustrates a process for operation of an auxiliary advising system to monitor machine operation according to one or more embodiments;

FIG. 2B illustrates a process for determining labeled datasets for operation of an auxiliary advising system to monitor machine operation according to one or more embodiments;

FIG. 3 depicts a manufacturing environment including an advisory system according to one or more embodiments;

FIG. 4 illustrates a graphical representation of functional modules according to one or more embodiments;

FIG. 5 illustrates a graphical representation of interaction context detection system according to one or more embodiments;

FIG. 6 illustrates a graphical representation of an adaptive learning process according to one or more embodiments;

FIG. 7 illustrates a graphical representation of phased development of an adaptive machine learning model according to one or more embodiments;

FIG. 8 illustrates a graphical representation of a static design phase of an adaptive machine learning model according to one or more embodiments;

FIG. 9 illustrates a graphical representation of a deployment phase of an adaptive machine learning model according to one or more embodiments;

FIG. 10 illustrates a graphical representation of an anomaly prevention process according to one or more embodiments;

FIG. 11 shows a contextual sensor system 1100 configured to utilize a finite state machine (FSM) model including workers and machines and correlated through state transition function according to one or more embodiments;

FIG. 12 illustrates an exemplary power data and image data captured for a machine operation according to one or more embodiments;

FIG. 13 illustrates context extraction between pumping states including time states and illustrates a difference between predicted power usage and detected power data according to one or more embodiments;

FIG. 14 shows a three phased approach for an interactive cyber physical human system (ICPHS) framework according to one or more embodiments;

FIG. 15A illustrates an example of a static ontology model of a machine used for semiconductor reactive ion etching and chemical vapor deposition according to one or more embodiments;

FIG. 15B illustrates a dynamic knowledge graph converted from SOP of a machine according to one or more embodiments; and

FIG. 16 illustrates a process for extracting causal relations from existing knowledge using ontology and dynamic knowledge graph representation according to one or more embodiments.

### DETAILED DESCRIPTION OF THE EXEMPLARY EMBODIMENTS

### Overview and Terminology

One aspect of the disclosure is directed to auxiliary advisory systems and methods for manufacturing and machine control. Embodiments for auxiliary advisory systems may be used with control systems of machines. Embodiments provide capabilities of adaptive learning and context-awareness. Embodiments described herein also provide at least one of a standalone system and complimentary system for use with machine operation, industrial applications, and manufacturing systems.

Disclosed and described herein are systems, methods and configurations for auxiliary advising. Auxiliary advising may be provided to assess interactions between components of a machine operation, including one or more of a worker, machine and material that is processed. According to embodiments, sensors are used to detect interactions between objects of a machine operation, such as an interaction of a worker and a machine. Objects of the machine operation may be assigned and/or associated with object states. Object models may be developed according to embodiments for objects with respect to machine operations.

According to embodiments, systems and methods generate and determine finite state machine mapping from interactions of two or more objects. Interactions may be detected and used in timing and logic analysis. According to embodiments, as soon as the timing and logic information of workers, machines, and materials become available in a manufacturing environment, a logic instruction (such as advice) may be provided to an existing manufacturing system in real time for optimizing the existing practice. In addition, embodiments provide causality induced self-labeling for adaptive machine learning. One or more causality models described herein can be machine learning (ML) models configured to be self-adaptive to the deployment environments, which alleviate the barriers of manual data collection and annotation and solves the problem of machine learning adaptation. Embodiments provide methods for generating labeled datasets for operation of an auxiliary advising system to monitor machine operation. Embodiments for systems and processes described herein may utilize sensors and sensor data to detect state transitions of one or more objects, and to label data and data segments associated with a state transition. By providing a sensor data driven solution, state transitions may be used as an indicator for labeling data segments. Labeled data for an object may be used to detect state transitions during machine operation. Labeled data may also be used to evaluate causal relationships between objects of a machine operation. Labeled data may also be used for devices and processes to self-label one or more segments of detected data.

According to another embodiment, methods are provided for operation of an auxiliary advising system to monitor machine operation. Machine control can accept inputs from sensor data, such as PLC/SCADA data, and other complementary information regarding the manufacturing environment and infrastructure. An auxiliary advising system can process the data by advanced data analysis methods, and provide advice about the context adaptation to the existing manufacturing control systems and operators. The provided advice can assist and improve existing manufacturing systems adapt to the change of manufacturing conditions and environmental constraints, such as rescheduling workflows depending on condition changes, anomaly prevention, and adaptive monitoring of workflows. Embodiments include the methods of developing the advisory system with the capability of adaptive machine learning.

Embodiments are also provided to extend an auxiliary advisor tool to existing control systems. Embodiments can capture additional dimensions of data outside of the manufacturing processes and existing control systems, and generate additional actionable intelligence for adaptation regarding the improvement of energy efficiency, productivity and integrity of manufacturing workflows. The adaption of manufacturing processes includes the adaptation to abnormal situations and the adaptation to environmental condition changes and can reduce the energy and material consumption and improve the productivity. The adaptation of the detection models residing in the advisory tool can allow the detection models adapt to the deployment sites to improve its detection accuracy without the efforts of human interventions, such as manual data labeling, and requiring less intrusive work at the manufacturers. Embodiments provide a view of outside-in information and context-awareness. The introduction of machine learning process to an advising tool can enable capability of perception.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment,” “certain embodiments,” “an embodiment,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics may be combined in any suitable manner on one or more embodiments without limitation.

### Exemplary Embodiments

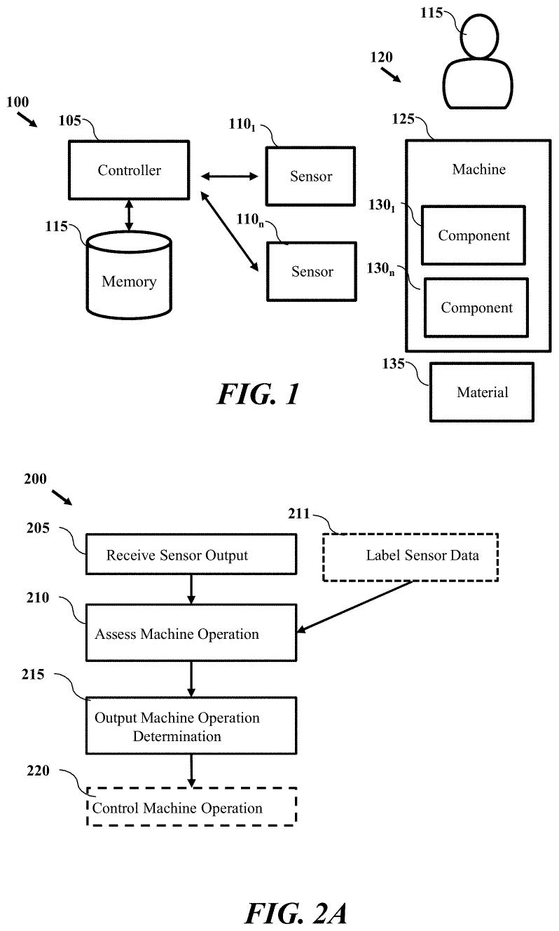

FIG. 1 is a graphical representation of an auxiliary advising system to monitor machine operation according to one or more embodiments. According to one embodiment, systems, methods and device configurations are configured to detect interactions relative to one or more of machines, workers and materials by auxiliary advising system 100.

According to embodiments, system 100 is an auxiliary advising system and can include controller 105, at least one sensor, such as sensors 110₁₋ₙ, and memory 115. As shown in FIG. 1, system 100 operates to detect and analyze a machine operation 120 which can include one or more of worker 115, machine 125 and material 135. Machine 125 may include one or more components 130₁₋ₙ.

As discussed herein, system and device configurations and processes may be employed by system 100 to build a model of interactions for machine operation 120. Domain information and data from sensors 110₁₋ₙ may be used in combination with sensor data and process operations to detect interactions and generate a model for machine operation. System 100, as an auxiliary advising tool, can detect and improve use of machines, including improving energy efficiency.

According to embodiments, system 100 is an energy efficiency and productivities improvement system for advanced manufacturing. System 100 may be a monitoring system in a manufacturing environment to gather intelligence in the context of manufacturing workflow with capabilities of detecting real-time worker/machine interaction, worker/materials interaction, and machine/materials interaction via video (time stamped information) and additional sensors, for example, power meter, etc. The situations of a machine or component state, of worker safety and health, and of materials consumption and waste can be determined for deriving actionable intelligence in improving energy productivities. System 100 may be a monitoring and advising system for situation and contextual awareness that operates as a “wingman” for any existing manufacturing automation system controlled by worker manually, by programmable logic control (PLC), or by supervisory control and data acquisition (SCADA). Embodiments herein describe a method of designing and implementing one or more components of system 100 by using the causality underlying various interactions to achieve a data self-labeling mechanism allowing a self-adaptive learning without human intervention.

System 100 may act as an auxiliary advisory tool to capture outside-in information for existing manufacturing systems. As such, system 100 can enable the adaption of manufacturing processes and the adaptation of the detection models (such as machine learning models) residing in the advisory tool. The adaption of manufacturing processes includes the adaptation to abnormal situations and the adaptation to environmental condition changes and can reduce the energy and material consumption to improve productivity. The adaptation of the detection models residing in the advisory tool can allow the detection models to adapt to deployment sites in order to improve detection accuracy without the efforts of human interventions, such as manual data labeling, and requiring less intrusive work at the manufacturer. Current manufacturing control systems lacks the view of outside-in information and context-awareness. The introduction of machine learning enables capability of perception.

System 100 can detect and analyze machine operation 120 including characterizing interactions relative to one or more of worker 115, machine 125 and material 135. According to embodiments, system 100 includes a first sensor, such as sensor 110₁, configured to detect a state of a first object of machine operation 120, and a second sensor, such as sensor 110ₙ, configured to detect a state of a second object of the machine operation. According to embodiments, the first object is one of a machine, worker and material, and the machine operation includes at least one interaction between the first object and the second object. By way of example, sensor 110₁ may be configured to detect operations and/or interactions of worker 115 while sensor 110ₙ, may be configured to detect operations of component130₁. Alternatively, sensor 110₁ may be configured to assess material 135 and sensor 110ₙ, may be configured to assess machine 125. Embodiments herein describe an exemplary use of two sensors, however, it should be appreciated that a plurality of sensors (e.g., more than two sensors) of system 100 may be employed at the same time or time intervals. With respect to sensors 110₁₋ₙ, system 100 may employ one or more types of sensors. According to one embodiment, for example, a first sensor, such as sensor 110₁, is a camera sensor and the second sensor, such as sensor 110ₙ, detects power usage of at least one component, such as component 130₁, of machine operation 120. It should be appreciated that other types of sensors may be employed including but not limited to sensors to detect sound, temperature, weight, dimension (e.g., thickness), and machine output in general.

As shown in FIG. 1, controller 105 is coupled to sensors 110₁₋ₙ and sensor output is processed to determine one or more states of objects of the machine operation. According to embodiments, controller 105 is configured to receive the state of a first object and the state of a second object based output of sensors 110₁₋ₙ. Controller 110 is configured to assess machine operation using a causality model for at least one of the first object and second object. According to embodiments, a causality model may provide a model of sensor data relative to machine operation 120. By way of example the model of sensor data can include a sample of representative data output for a sensor based on standard operating procedure for a machine operation. The causality model can include a labeled dataset for machine operation. Labeled data, for example, may include a data segment for a period before a transition to a period following a transition for a first object. A labeled data set may include a data segment for a time period associated with transitions for a first object and a second object. According to embodiments, the causality model of the machine operation is determined using a model for each of the first object and the second object. The causality model can provide a model for interactions between the first object and the second object, wherein the causality model includes parameters for at least one of cause and effect of interactions, state of cause and effect of interactions, time interval between cause and effect of interactions, and transition of cause and effect states, controller labels sensor data.

According to embodiments, sensors of system 100, such as a first sensor and second sensor, detect operations of objects, such as a first object and a second object. The state of the first object and the state of the second object are each finite states of a finite state machine model for the machine operation. System 100 may use models for objects and characterize states of an object based on sensor output. The labeled dataset may identify interactions of objects with sensor output.

Each machine of system 100 can be equipped with multiple functional components to achieve different functions for a manufacturing process. In one exemplary embodiment, system 100 provides a solution to identify worker actions and machine/component status in real time with the adaptation capabilities to ever-changing environments. The function of worker action classification and the function of machine/component status in the form of software can be improved automatically and adaptively after the two functions are deployed to the deployment sites, such as the manufacturing shop floors, without human interventions. According to embodiments, automatic adaption is achieved in the form of automatic data collection and annotation from the deployment environment, and in the form of automatic machine learning model retraining on the data. After an adaptation process, the well-adapted functions can provide additional non-intrusive information towards the manufacturing processes beyond the existing machine control paths of SCADA, PLC or operator to develop applications in the field of energy efficiency and anomaly detection.

According to embodiments, sensors 110₁₋ₙ may be visible light cameras and power meters as the data acquisition sensors. The sensed data is transmitted through a network to a computer-based processor, such as controller 105. According to embodiments, controller 105 can include data processing modules including worker interaction detection, machine/component state detection, and adaptive learning system. The worker interaction detection module processes video data in real time to classify the worker actions which can be quantified as finite states. The machine/component state detection module processes power data in a time series format to classify the state of a machine or its individual component. The adaptive learning system leverages the consistency between worker and machine state transitions to automatically collect and label incoming video and power data for retraining machine learning models inside the worker interaction detection module and the machine/component state detection module to achieve self-adaptation. Data processing modules may be embodied in controller as one or more executable instructions stored in memory 115 and executed by controller 105. Based on the executed instructions controller 105 may output one or more determinations. According to embodiments, context adaptation by controller 105 provides a determination for sensed data compared to historical data for the machine operation to include at least one of an alert of a data shift, deviation from data pattern and change in environmental condition. Interaction context detection by controller 105 can provide a determination of at least one causal interaction between the first object and second object and a determination of a source of an interaction. Anomaly prevention by controller 105 labels at least a portion of collected data for the machine operation as an anomaly.

According to embodiments, machine operation is assessed by system 100 using a trained dataset for interactions between the first object and the second object. The trained dataset may be generated for the machine operation using a machine standard operating procedure and at least one machine component. Controller 105 is configured to output a machine operation determination including at least one of a context adaptation output, interaction context detection output and anomaly prevention output.

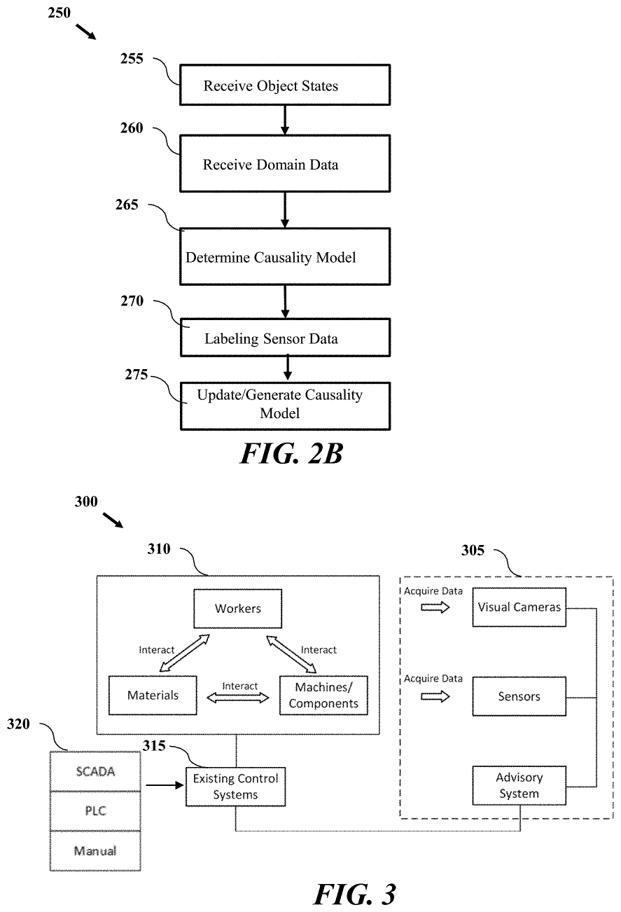

FIG. 2A illustrates a process for operation of an auxiliary advising system to monitor machine operation according to one or more embodiments. Process 200 may be performed by controller 105 of system 100 of FIG. 1 to determine one or more machine operations determinations and to provide an auxiliary advising system. According to embodiments, process 200 may be initiated at block 205 by receiving output from a first sensor configured to detect a state of a first object of the machine operation, and output from a second sensor configured to detect a state of a second object of the machine operation. According to embodiments, process 200 may receive sensor data from a first and second sensor for a machine operation (e.g., sensors 110₁₋ₙ) at block 205. The sensor data may be detected to characterize operations of objects and to determine interactions between objects including changes in states. According to embodiments, sensor data may be image data captured by camera sensors, power meters to detect power usage, temperature sensors, and machine operation sensors in general.

At block 210, the controller can assess the machine operation using a causality model for the objects, such as one or more of a machine, worker and material. Machine operation can include at least one interaction between objects and a causality model may include a labeled dataset for machine operation. According to embodiments, a causality model provides a model for interactions between the first object and the second object. By way of example, the causality model can include one or more data segments as examples of sensor output for machine state changes and/or machine operation. These data segments may form a labeled dataset that is included in and may be used by the causality model. As such, labeled data may be used to identify machine operations including causal state transitions for at least one of the first object and second object. The causality model may also be used by a controller to label data segments based on state changes. Process 200 may use a causality model of the machine operation that is determined using a model for each of the first object and the second object. By way of example, operation of each object may be characterized by a machine model, such as a machine learning model for an object. The labeled dataset may be used by a causality model to identify interactions of objects from sensor output. According to embodiments, the causality model provides a model for interactions between the first object and the second object, wherein the causality model includes parameters for at least one of cause and effect of interactions, state of cause and effect of interactions, time interval between cause and effect of interactions, and transition of cause and effect states, that a controller may use to label sensor data.

Operations at block 210 may be assessed based on labeled sensor data. Machine operation may be assessed using a trained dataset for interactions between the first object and the second object. The trained dataset may be generated for the machine operation by mapping sensed data to standard operating procedure of at least one machine component. The trained dataset can include one or more labeled data segments. According to embodiments, process 200 may optionally include labeling sensor data at block 211. Sensor data may be labeled as discussed herein with respect to FIG. 2B.

At block 215, the controller may output a machine operation determination including at least one of a context adaptation output, interaction context detection output and anomaly prevention output. Machine operation may be assessed at block 215 using a trained dataset for interactions between the first object and the second object, the trained dataset generated for the machine operation using a machine standard operating procedure and at least one machine component. According to embodiments, outputting a machine operation determination can include annotating sensor data of an object (e.g., a first object) of the machine operation to include a label in response to detection of a state transition in at least one data segment for a another object (e.g., a second object). Output of a machine operation determination may include one or more of labeled data and updates to a causality model.

Controller 105 is configured to output a machine operation determination at block 215 including at least one of a context adaptation output, interaction context detection output and anomaly prevention output. The context adaptation output may provide a determination for sensed data compared to historical data for the machine operation to include at least one of an alert of a data shift, deviation from data pattern and change in environmental condition. The interaction context detection output may provide a determination of at least one causal interaction between the first object and second object and a determination of a source of an interaction. The anomaly prevention output labels at least a portion of collected data for the machine operation as an anomaly.

Process 200 may optionally include controlling machine operation at block 215. According to embodiments, process 200 may output a control command to stop a machine operation when an anomaly is detected.

FIG. 2B illustrates a process for operation of an auxiliary advising system to label datasets according to one or more embodiments. Process 250 may be performed by controller 105 of system 100 of FIG. 1 to determine a causality model for an auxiliary advising system to monitor machine operation. Process 250 may be initiated at block 255 with receiving, by a controller, a plurality of defined first object (e.g., object 1) states and a plurality of defined second object (e.g., object 2) states. Process 250 may be performed for a machine operation including at least one of a machine, worker and material, and the machine operation including at least one interaction between the first object and the second object.

At block 260, domain data may be received or the first object and the second object, the domain data including a standard operating procedure for the first object and the second object in a machine operation.

At block 265, a causality model is determined. According to embodiments, a causality model at block 265, and as used herein, may be a model for two or more objects. Systems and processes as discussed herein may determine multiple causality models for assessing machine operation. According to embodiments, for assessing two objects, the two objects will collectively have one causality model that defines the causal relationship between the two objects. The causality model can include as inputs one or more of object states, state transition relationships, cause and effects relationships among objects states, and the temporal relationships of states transitions (i.e., the time interval). According to embodiments, each object can include a corresponding data processing model (e.g., machine learning model) used for processing object sensor data to detect the real-time object state. The causality model may be configured to label sensor data. Embodiments are configured to provide self-labeling, such that a controller may label or assign sensor data in response to state changes without the need of an operator (e.g., human) to label the data. Embodiments may use ML models used for data processing of object data. Labeling of data, such as self-labeling, may be one output of a causality model based on detected state transitions and temporal information. The causality model may take as inputs and/or determine one or more of object states, timing of states and, cause and effect for the first object and the second object in the machine operation. Determination of a causality model at block 265 may include identification of machine operation states to assess for each of the first object and the second object. At block 270, labeling sensor data associated with machine operation may be performed for at least one of identifying and labeling data segments showing interactions of objects based on state changes in sensor output.

A controller may label data for one or more interactions and for use in assessing one or more of context adaptation, interaction context detection and anomaly prevention. According to embodiments, labeling sensor data at block 270 may be a self-labeling or automatic labeling operation. A causality model may be different from a data processing model (e.g., machine learning model) that requires a dataset for training. According to embodiments, a causality model has the capability of self-labeling data based on the state transition mapping and corresponding temporal relationships of state transitions of two objects.

According to an exemplary embodiment, labeling may include an automatic or self-labeling function that when a first ML model detects the state transition of the first object, based on the causal mapping of state transitions, the causality model can map the detected object state to the corresponding cause or effect state of the second object. The causality model may be configured to integrate the causal relationships of multiple objects of causes and effects, such as two objects as causes and one object as an effect. By way of example with respect to a two-object scenario including a first object (e.g., object 1) with a first sensor (e.g., sensor 1) detecting operation of the first object, and a second object (e.g., object 2) with a second sensor (e.g., sensor 2) detecting operation of the second object. The state of the second object may then be used as a label for a segment of sensor data associated with a second object. After the label is derived, a segment of a second sensor data associated with the second object is selected and labeled. The selection of the data segment of the second sensor is based on the temporal relationships of state transitions in the causality model. That is knowing the timestamp of when the first object changes states and the time interval between the state change of the first object and the second object from the causality model, the segment of data for the second sensor with the corresponding timestamps can be selected and annotated with the derived label. Thus, a new data point with a label may be derived and saved for the second ML model training.

According to embodiments, labeling sensor data may be based on an interaction. A controller may detect and determine the temporal time period for an interaction. By way of example, a controller may determine an interaction starts at time 0, the machine state change will be recognized at time T₁+Tᵣₑₛ, where T₁ is interaction duration and Tᵣₑₛ is response time. The temporal relation is to start from T₁+Tᵣₑₛ to pinpoint the interaction period (0, T₁). To adequately cover more informative data segment due to time variations, one or more of a one-step and two-step back tracing step size may be used.

At block 275, process 250 includes updating/generating the causality model in response to labeling of sensor data at block 270. According to embodiments, the causality model provides a model of interactions between the first object and the second object. The causality model can include parameters for at least one of cause and effect of interactions, state of cause and effect of interactions, time interval between cause and effect of interactions, and transition of cause and effect states. According to embodiments, a causality model can be used by a controller to label data segments and to characterize sensor output.

FIG. 3 depicts a manufacturing environment including an advisory system according to one or more embodiments. Embodiments described herein provide solutions in manufacturing environments with multiple machines, multiple workers, and multiple materials. Systems, devices and processes describe herein can provide an auxiliary advisory system to offer adequate recommendations for existing manufacturing systems either with manual operation or automation control, such as PLC and SCADA, for improving energy productivity as the manufacturing conditions and environmental constraints evolve. FIG. 3 illustrates manufacturing environment 300 including an auxiliary advisory system 305, machine operation 310, existing control system 315 and control data 320. Embodiments of the disclosure can operate independently of existing manufacturing control systems while advising them, i.e. people (manual control) or PLC/SCADA (automation control), with situation and context awareness instructions for taking actions in continuously optimizing its operation control algorithm. Embodiments of the disclosure can perform tasks like a “wingman” for advising existing manufacturing practices. According to embodiments, manufacturing context awareness includes contextual information not only of interactions among workers, machines, and materials, but also of the objects involved in interactions, the status/state of involved objects, the timestamp of interactions, and the causes and effects of interactions. Context determined by an auxiliary advising system can further include complimentary information influencing manufacturing productivity in other perspectives such as environmental factors, i.e. availability of renewable energy from weather forecast, and industrial building infrastructure support information such as compressed air, chill/hot water, HVAC, etc. Interactions may be relative to workers and machines, workers and materials, and machines and materials, representing workers operating machines, workers handling or inspecting materials, and machines processing materials respectively. According to embodiments, interactions need to have two or more objects involved. Two or more sets of sensors, where at least one set of sensors are visual cameras, are applied to capture data from the two or more objects involved in interactions respectively for their interaction confirmation. According to other embodiments, advanced data analytical methods, such as machine learning (ML) models, are applied to the two or more sets of data to identify the interaction contexts, where the causal relationships of interactions can enable adaptive learning capability for improving ML model performance. Based on the contextual information of interactions and complementary information, the auxiliary advice is provided to existing manufacturing systems including actionable intelligence for existing manufacturing systems to respond, for example, worker error prevention for process integrity, machine/component integrity forecast for preventive maintenance, energy availability for production scheduling, health and safety of working environment for workers, and real time dynamic control of machine operation for energy productivity improvement.

Manufacturing facilities may employ control of machines that can be categorized into three levels, namely supervisory control and data acquisition system (SCADA), programmable logic controller (PLC) process control, and manual control. The manual control system has the lowest level of automation. The machine or its component is controlled by a worker manually through the machine/component interfaces, such as switches and buttons, with the feedback from analog or digital meters measuring certain process or other related environmental conditions. The machine and component can have multiple energy states. The machine or component is controlled by a worker following certain operating procedures or machine manuals. The PLC control system integrates the function of process or related environmental condition monitoring and the function of machine/component control. The PLC control system can automatically execute one or more processing steps according to initial input from a worker and current related conditions. That is, compared with manual control, a group of related processing steps carried out by corresponding machine components can be automatically executed by PLC control system. Worker input can be the initial commands of start, process recipes, recipe programming, and other necessary commands to be input to PLC to start, pause, or stop the automatic control. Worker input is entered through PLC interfaces. The SCADA control system can include computers, sensors, networked data communications, user interfaces and other related electronic devices (such as PLC) for high level supervision of machines and processes in a plant. The SCADA system is able to monitor and control an entire plant. Compared with PLC control, SCADA control requires less worker interventions and keeps higher automation level. Embodiments can serve as an auxiliary advising tool to the three manufacturing control systems. Since the three systems have different automation levels, access and collect different levels of data, and provide different levels of user interfaces, embodiments can provide additional appropriate advice to the existing systems, for example, directly informing workers/supervisors for taking actions in manual system, sending commends to PLC for idling time control, and advising SCADA for scheduling with availability of renewable energy.

FIG. 3 illustrates an exemplary auxiliary advisory system 305 configured to observe interactions of machine operation using non-intrusive sensors. One or more video cameras and other types of plug and play sensors, depending on application scenarios, are used to acquire data from the involved objects. System 305 may be an example of system 100. Sensors of system 305 may be consumer grade sensors. Based on the minimum requirement of interaction of two objects, sensors should offer time stamped data of individual objects when objects take actions or respond to actions. In FIG. 3, since the video camera is used as one of two sensors, public training sets of data can be leveraged for initial designs of static learning systems according to embodiments.

According to embodiments, auxiliary advisory system 305 is configured for identification of interaction contexts to determine causality during interactions. For example, during an interaction between two objects, earlier action by one object may be determined as the cause to induce the corresponding effect on the other object. The one-to-one mapping condition and the temporal condition establish a state transition function of a finite state machine model, according to embodiments. There are two aspects of the causal interactions according to embodiments. One aspect is that the causal relationship is already known and established, and can be summarized from available knowledge from humans or documents, such as a machine's standard operating procedure from existing manufacturing systems. The other aspect is that the effect is known and can be perceived by experienced workers or by causality observing sensors where the cause remains unknown or unclear. For the first aspect with the well-established causality, the states of involved objects can be causally correlated by a controller to achieve the self-labeling of dynamic data for adaptive machine learning models. According to embodiments, the sensor used in confirming the interaction from its effect for serving as a labeling mechanism is selected based on the informed causality. Detected effects may include one or more of power signature, acoustic signal emission, infrared (IR) signal from heat, etc., in response to the interaction causes. Sensors of auxiliary advisory system 305 can detect data for at least two major functions: 1) sensed data offers real time measured quantity of subject responses for situation awareness, and 2) sensed data incorporation with finite state machine models to confirm the interaction is used as a signal for label free adaptive leaning algorithm in ML at field deployment site. Interaction context detection as used herein can achieve these two functions in the first aspect. For the second aspect with unknown or unclear cause, the worker cognition and intelligence, or unsupervised data mining techniques, may be leveraged to discover the potential cause for making existing manufacturing systems more robust and allowing continuing evolution for better performance. Once the cause is identified, machine learning algorithms are trained with the collected data to identify the cause before the effect happens to achieve preventive measures. Features directed to an anomaly prevention system are provided for the second aspect.

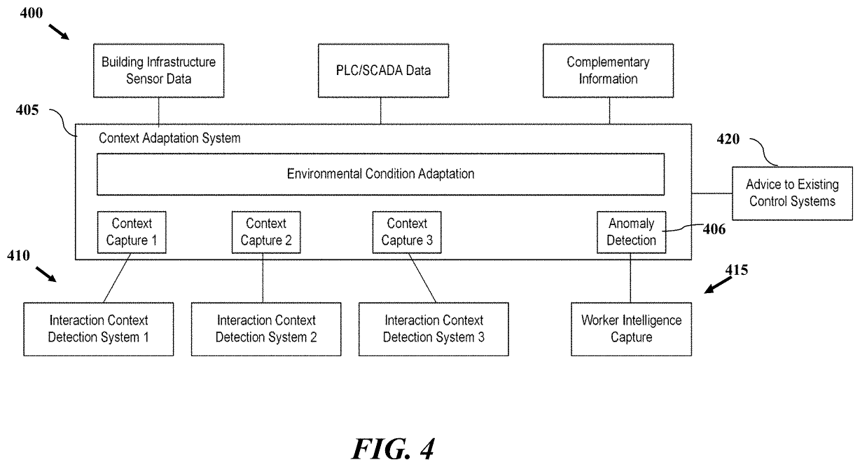

FIG. 4 illustrates a graphical representation of functional modules 400 of an auxiliary advising tool according to one or more embodiments. According to embodiments, functional modules 400 may relate to sub-systems including a context adaptation system, one or multiple interaction context detection systems, and an anomaly prevention system. For each set of interactive objects, an interaction context detection system is included. Functional modules 400 include context adaption system 405 configured to receive sensor data and capture contextual information from one or more components of a machine operation. An advisory tool may include a plurality of interaction context detection system functions 410 to assess interaction. According to embodiments, context adaption system 405 may include an anomaly detection module 406 configured for worker intelligence capture shown as 415. According to embodiments, context adaption system 405 may include functional module 420 for advice to existing control systems. Functional modules 400 may receive data from machine operation including building infrastructure sensor data, PLC/SCADA data and complimentary information data for machine operations.

According to embodiments, functional modules 400 provide a context adaptation system 405 and advice generation unit 420 by fusing multiple information sources to provide advice for adapting to the current manufacturing contexts and machine operations. Functional modules 400 of an auxiliary advising tool can include several built-in functions, including context capture, anomaly detection, and manufacturing environmental condition adaptation. According to embodiments, each interaction context detection system sends detected object states and raw data to a corresponding context capture system. Each context capture system has a built-in function to detect the longitudinal change of historical data. Based on the historical data shift, context capture systems can also have a built-in function to predict data shifts. The historical data can include data from objects involved in the corresponding interaction. The implementation of this built-in function can be data analysis methods, such as trend analysis, regression, correlation analysis, and machine learning. A second function of context adaptation system 405 is the anomaly detection. The anomaly detection has a built-in function to discover the repetitive patterns from the accumulated anomaly data to identify the cause of the anomaly. It also has a built-in function to, once the cause is identified, predict the anomaly data before it happens in the future. The third function of context adaptation system 405 is the environmental condition adaptation. Context adaptation system 405 can receive data from other infrastructure sensor data, and/or available data from PLC and/or SCADA, and/or other available complementary information. Context adaptation system 405 may be configured to fuse the information from the data sources and from the context capture modules and adapt to the environmental condition change. The environmental condition change has been described above. This module can reschedule the manufacturing work based on the change of these environmental conditions and the current status of the shop floor. The three modules can generate advice to the existing control systems based on their functionality. Advice generation unit 420 may be configured for monitoring function of worker/machine/material activities, the integrity of workflows, the preventive measures for anomalies, and rescheduling workflows depending on environmental conditions.

According to embodiments, functional modules 400 includes anomaly detection module 406 as a prevention system to allow onsite workers to report alarms when workers observe anomalous events. Anomaly detection module 406 can include a worker intelligence capture module and an anomaly module that resides inside the context adaptation system. When anomaly detection module 406 receives an alarm from workers detected by the worker intelligence capture module, anomaly detection module 406 can start saving the data from certain regions where the alarm is generated and/or available data for the past several minutes, and label this part of data as anomaly. The data to be saved can include senor data in interaction context detection systems, and/or building infrastructure sensor data, and/or PLC/SCADA data, and/or the complementary data. Worker alarms can be in the form of predefined body gestures recognized by machine learning models. Worker alarms can also be in the form of voice keyword triggering.

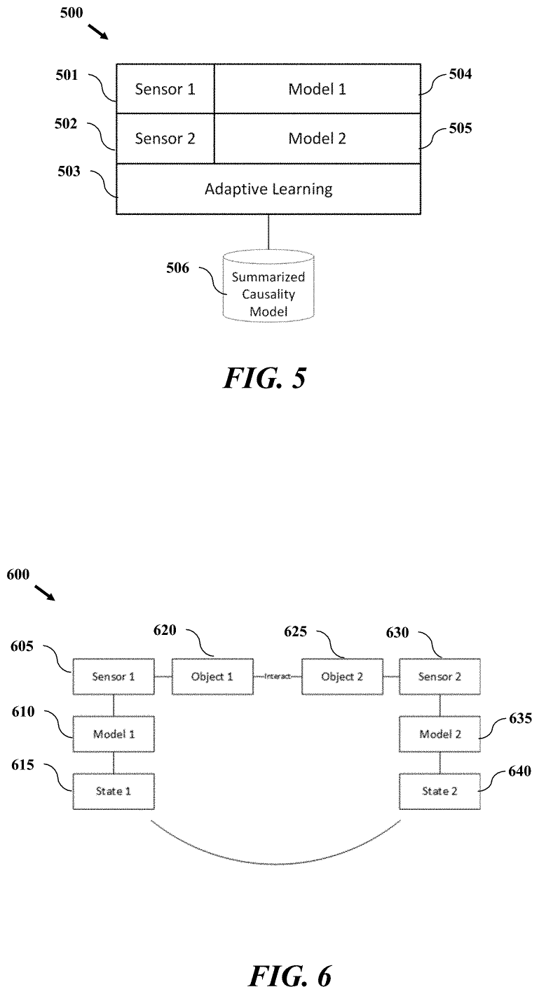

FIG. 5 illustrates a graphical representation of interaction context detection system 500 according to one or more embodiments. Implementation of an interaction context detection system and an anomaly prevention system may be based on causality induced self-labeling. Operations by a controller (e.g., controller 105) of an auxiliary advising tool may be configured as interaction context detection system. With respect to an auxiliary advising system for a machine operation, a set of interactive objects can be various numbers of machines, machine components, workers, and materials. In one exemplary scenario, a first object may be a machine, or a portion of a machine such as a control knob, button, machine part, etc. A second object may be a worker. System 500 may include a sensor for each object. By way of further example, a sensor for a machine object and a sensor for a worker/machine operator. Adaptive learning may be performed by a controller to detect interactions and sample sensor data.

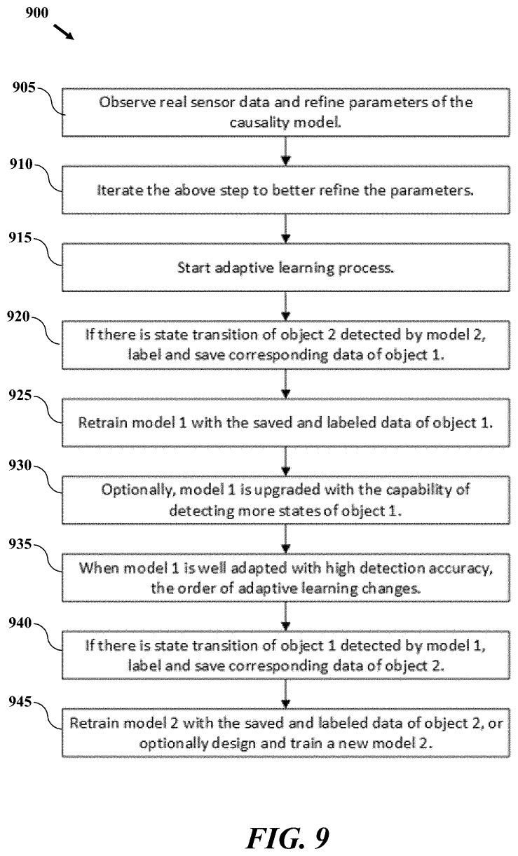

According to embodiments, interaction context detection system 500 includes a set of sensors, such as sensors 501, 502, a set of data analysis models, such as models 504, 505 and adaptive learning module 503. Data analysis models are described with reference to FIG. 6 and may be machine learning models. Adaptive learning at block 503 may include one or more operations for detecting, characterizing and labeling sensor output, such as operations described with reference to FIG. 9. Using sensor data and models 504, 505, wherein each model is directed to a particular sensor, interactions may be detected. By way of example, using a standard operating procedure, sensor data may be correlated to machine actions occurring a known time intervals, and data corresponding to the time intervals may be associated with one or more actions of the machine operation.

System 500 can include a summarized causality model 506 generated from interactions. According to embodiments, a causality model may incorporate existing knowledge of humans and documents as input to an adaptive learning module as the foundation of adaptive learning. According to embodiments, a set of interactive objects needs at least two data processing models for processing at least two sets of sensor data. Each set of interactive objects can have same or different data processing models, same or different types of sensors, and same or different causality models. In an auxiliary advising system, each interaction context detection system receives data from at least two sensors that are installed to acquire signals from the at least two objects respectively involved in interactions.

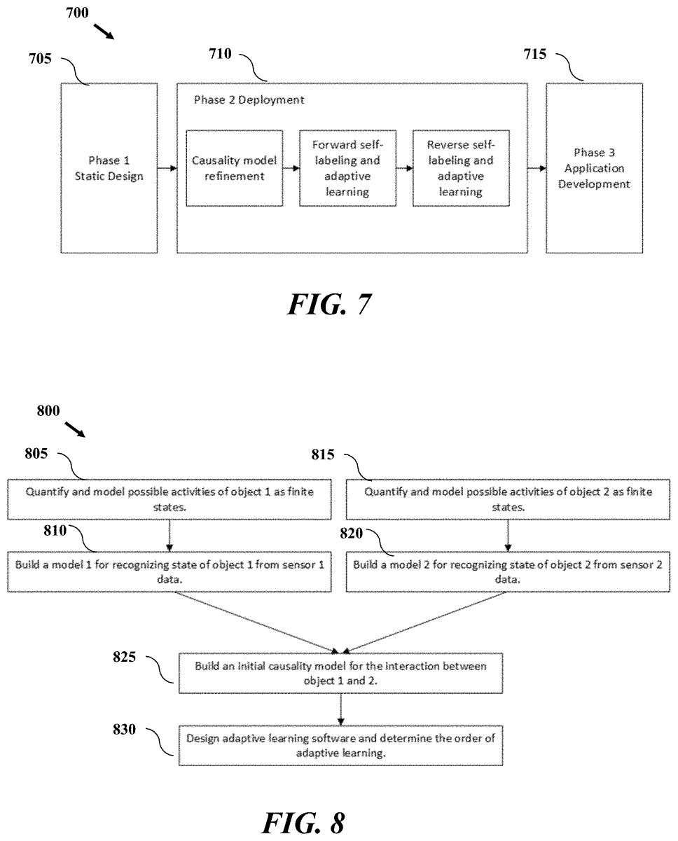

FIG. 6 illustrates a graphical representation of an adaptive learning process 600 according to one or more embodiments. According to embodiments, for a first aspect of causal interactions, the observation of interactions can be used to adaptively train machine learning models for recognizing the involved object states. Recognized object states in real time can be used to check the process, machine, or component integrity as a way to offer situation awareness to interested decision makers such as worker or supervisors. FIG. 6 illustrates a two-object interaction as an example. Two sensors, sensor 605 and sensor 630, are used to collect data from the two objects, object 620 and object 625, respectively. Sensor 605 and sensor 630 are configured to sense properties of object 620 and object 625. The status of objects can be quantified as finite states, such as state 615 and state 640. For example, a piece of material has different states after different processing steps. Machine activities can be defined to include multiple states, such as off, on, standby. It is noted that a machine at ON state can include multiple sub-states representing multiple component functioning states. For example, a motor running for drilling a hole on a piece of metal sheet while a heater is on for elevating metal sheet temperature requirement at certain steps and cooling at other steps. Worker actions such as movements by hands, body and feet can be defined as worker states representing interactions. Some data processing techniques, such as machine learning models, can be applied on the two sets of data from the two sensors respectively to recognize the interaction states of the two objects. The adaptive machine learning can be achieved in the following way in three phases as shown in FIG. 7. In the example of a two-object interaction, a goal of the adaptive machine learning is to build two machine learning models that are well adapted to the deployment environment gradually without the need of manual data annotation by humans. The two machine learning models, model 610 and model 635, use the two sensor data as inputs to generate the states of the two objects. The machine learning models can be retrained with the data collected and annotated automatically from the deployment environments to gain better performance, i.e. higher detection accuracy or more fine-grained classifications.

Adaptive learning process 600 may be applied to detect and categorize interactions. Interactions can provide contextual information of the workers, machines, and materials. Adaptive learning process 600 may also obtain contextual information available about manufacturing environments. For example, systems described herein can interface between the advisory system and the database of the availability of renewable energy or energy price. The contextual information gained from the plant status can be combined with the context of renewable energy to provide advice to existing control systems regarding the work rescheduling. This allows more energy intensive work to be performed at the time when renewable energy is available, while meeting production quota requirement.

FIG. 7 illustrates a graphical representation of phased development of an adaptive machine learning model according to one or more embodiments. Process 700 includes phase 1 for static design shown as 705, phase 2 for deployment shown as 710, and phase 3 for application development, shown as 715. According to embodiments, initially, in phase 1, the states of the two objects and the causal relationships of the states of the two objects are defined according to the available domain knowledge. The available domain knowledge may be obtained from process manuals, machine manuals, standard operating procedures, or other similar forms. The causal relationships, or causalities, model the cause and effect relationships during the state transitions. A causality model is established to identify the cause and effect, the state of cause and effect, the time interval between cause and effect, and the transition of cause-effect states. The time interval is the time between when the cause is detected and when the effect is detected. Then, based on the domain knowledge, two data processing (e.g. machine learning) models, model 1 and model 2, are designed. Some public data sets can be selected depending on feature similarities with some feature transformation to pre-train the models. According to embodiments, a main channel and a causality observing channel are defined for the two data acquisition channels associated with the two sensors. The adaptive learning of the two models has a sequence. Each time only one ML model will be adaptively retrained and the other one provides the data annotation based on the causality. The main channel may be defined as the channel to optimize its performance through self-labeling. Causality observing channel is defined as the channel to validate events happened on the other side involved in the two-object interaction to generate monitor signals for annotating main channel data. The adaptive learning sequence may be first to adapt model 1, to start the adaptive learning, in phase 1, the model 2 can serve as causality observing channel to provide data annotation needs to be designed. Initially, the state of object 2 needs to be recognized by model 2 with high accuracy. Some signal or data processing methods, or unsupervised ML methods can be applied in this stage to get rid of data labeling of supervised ML model for designing model 2. The design process of model 2 can be assisted with available domain knowledge. In addition, the other model 1 can be pre-trained with some selected public data resembling the estimated data features. Optionally, some feature transformation, depending on use cases, can be applied on the selected public data to enhance the feature similarity.

According to an exemplary embodiment, assuming model 2 can recognize the states of object 2 with high accuracy, during deployment in phase 2, sensor 2 for object 2 will first serve as the causality observing channel to annotate the main channel data for object 1. With the collected and labeled data, the ML model for object 1 may be retrained adaptively. In some cases, the causality observing channel can label the main channel data with more detailed information. Therefore, compared with the pre-trained model in phase 1, the model 1 for object 1 can be retrained with the capability of recognizing more classes of states. When the model 1 is well-adapted, now model 1 can serve as the causality observing channel for annotating main channel data for object 2. Before in phase 1, the classifier for object 2 can be a naive classifier without model training. With a well-adapted model 1, the realistic data for object 2 can be labeled and collected and hence a more advanced classifier for object 2 can be trained.

With the self-labeled data as well as well-adapted models, applications can be developed. For the interaction context detection system, embodiments use machines of PLC control and of manual control with relatively low automation control levels as an example for illustration purpose. With the capability of effectively recognizing the states of objects, such as workers, machines, and materials, the interaction context detection system provides a non-intrusive workflow monitoring function to enhance the integrity of processes, machines, or components, and open an opportunity to optimize workflow for increasing energy productivity. For example, the states of workers, machines, and materials can be detected in real time to provide additional process or workflow information for supervisors and workers. Supervisors can check whether the current running workflow follows the work schedule. Workers based on their experience can check machine running status or material status to confirm the integrity of a machine or its component. Anomalous changes of individual component status for meeting the predefined process control in PLC in real time process will facilitate information of unstable operation conditions of individual components while an entire machine still functions normally as prescribed in PLC. These are an example of the contextual awareness intelligence offered according to embodiments to advise decision makers (workers or supervisors) with actionable intelligence and in some cases control machine operation. In addition to such real time applications, several asynchronous applications can be developed based on the self-labeled data and well-adapted models. For example, after long-term accumulation of data for a certain state of an object, the data deviation over time can be detected by using statistical analysis or unsupervised clustering methods to discover the degradation of certain attribute of the object. For example, in a worker-pump interaction scenario, the power data during the active state of a mechanical pump is collected over time by using the interaction context detection system. Active duration of pump can gradually become longer over time, which indicates that pumping the same volume of gas takes longer time. This can be used as a measure of predictive maintenance to service the pump. The use of longitudinal data together with data processing in searching for derivative change will offer contextual intelligence of individual component health inside a machine, which is valuable to decision makers in taking actions for preventative maintenance.

FIG. 8 illustrates a graphical representation of a static design phase of an adaptive machine learning model according to one or more embodiments. A static design phase, or phase 1, may be a static system design phase before deploying sensors and systems to the manufacturer. In this phase, the objective is to design an initial version of the worker action detection function, the machine/component state detection function, and the adaptive learning system by using existing knowledge from humans, machine manuals, machine instrumentation principles, and public data sets. Process 800 may be performed by a device for adaptive learning. Process 800 may include quantifying and modeling possible activities of a first object (e.g., object 1) as finites states at block 805 and quantifying and modeling possible activities of a second object (e.g., object 2) as finites states at block 815. At block 810, process 800 includes building a model for recognized states of the first object from a first sensor (e.g., sensor 1). At block 820, process 800 includes building a model for recognized states of the second object from a second sensor (e.g., sensor 2). At block 825, an initial causality model may be built for the interaction between the first and second objects. At block 830, an adaptive learning may be designed and order of learning may be determined.

According to embodiments, an adaptive learning mechanism leverages well established causality among worker machine interactions. For example, the standard operating procedure of a machine summarizes and defines the steps a worker needs to follow and the reciprocal responses from the machine or its components for the purpose of production. By way of further example, a worker's specific action of pressing a start button will cause a corresponding machine to be turned on. This causality may be well established in existing operator knowledge or in some existing documentation, and can be modeled as state transition relationships to achieve the self-labeling mechanism. That is, by knowing the state transition relationship between corresponding workers and machines, the detection of a machine state transition indicates a former worker state transition, and the detection of a worker state transition indicates a possible future machine state transition. With the time interval between the worker state transition and machine state transition being identified, when a machine state transition is detected, a period of former data captured from workers can be annotated with the information of machine state transitions and vice versa. In this sense, self-labeled datasets can be established from dynamic incoming data with high-fidelity annotations for both the worker and machine side sequentially. The self-labeled datasets can be used to retrain machine learning models to improve the detection accuracy.

FIG. 9 illustrates a graphical representation of a deployment phase of an adaptive machine learning model according to one or more embodiments. Process 900 may be performed by a device for phase 2 deployment operations. Process 900 may include observing real sensor data and refining parameters of a causality model at block 905. At block 910, the model may be iterated to refine parameters. Sensors and initial software may be deployed to proceed to phase 2. Initially in phase 2, the software of the initial version is refined with the observations from realistic sensor signals. For example, the time interval can be derived from several measurements and input into the adaptive learning system.

At block 915, an adaptive learning process may be initiated. The adaptive learning process may be performed using sensor data and by monitoring sensor data during known time periods. For example, a button press of a machine at time x, may be correlated to sensor output data of machine power at time x. Process 900 can include monitoring and quantifying possible activities of objects as finites states. Adaptive learning in process 900 may include use of a model for recognized states of the first object from a first sensor (e.g., sensor 1), and recognized states of the first object from a second sensor (e.g., sensor 2). Self-labeling may be performed by identifying a state change of an object using sensor output and then labeling at least a portion of sensor data. According to embodiments, a data segment preceding a state change, such as a time period leading up to the state change may be labeled as being associated with the state change. In certain embodiments labeling includes storing at least one of the sensor data, a representation of sensor data, and parameters describing sensor data. Labeling may include generating a representation of a data signal that may be used to compare with received data to characterize and/or detect similar states and/or state changes. Process 900 may include adaptive learning of machine states to label worker data and using worker state to label machine data. Self labeling of data may be conducted automatically and sequentially to let models adapt well for higher detection accuracy. At block 920, if there is a state transition of object 2 detected by model 2, data is labeled and saved corresponding to data of object 1. At block 925, model 1 is retrained with saved and labeled data of object 1. At block 930, optionally model 1 is upgraded with the capability of detecting more states of object 1. At block 935, when model 1 is well adapted with high detection accuracy, the order of adaptive learning changes. At block 940, if there is a state transition of object 1 detected by model 1, data of object 2 is labeled and saved. At block 945, model 2 is retained with the saved and labeled data of object 2, or may be optionally designed to train a new model 2. Self-labeling steps may be conducted on every machine individually. Self-labeling steps may be conducted on a single machine or multiple machines. In phase 3, several applications can be developed based on the self-labeled dataset and adapted machine learning models.

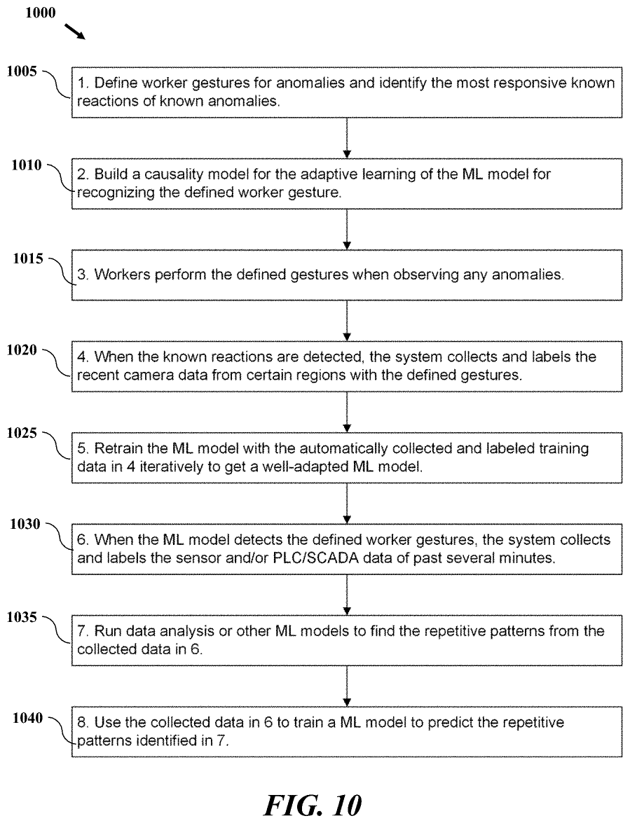

FIG. 10 illustrates a graphical representation of an anomaly prevention process according to one or more embodiments. Process 1000 for anomaly prevention can generate a machine learning (ML) model that can recognize worker movements and special body gestures as alarm signals from workers. Process 1000 for a ML model to recognize workers feedback through body gesture shares the same theory as the design of the interaction context detection system described above in FIGS. 5 and 6. The method is to use the same self-labeling method to collect and label data as the training set for the worker gesture training model.

Process 1000 may be initiated by defining worker gestures at block 1005. A worker gesture may be defined as a way to transmit anomaly messages. For example, workers may be are informed to perform the defined gesture towards system cameras when observing any abnormal events. At block 1005 the most responsive known reactions of known anomalies may be identified. At block 1010, a causality model may be built for the adaptive learning of the machine learning model for recognizing the defined worker gesture. A causality observing channel may be selected for labeling the worker gesture data. The selection of the causality observing channel is based on known reactions of some known abnormal events. The known reactions can come from existing control systems. An example is that the PLC or SCADA can control machines to be off when some abnormal events are detected. The known reactions can also come from other known sensor data that is most responsive towards any known anomalies. The known reactions towards known anomalies and the predefined worker gestures formulate the defined causality model for the adaptive learning of the worker gesture model. That is, the known anomalies can be sensed by the known reactions, and workers perform the predefined gestures when observing the same anomalies. In this way, by detecting the known reactions and certain response time, the data of the predefined worker gestures can be dynamically collected and labeled to train the ML model for recognizing the predefined gestures.

At block 1015, one or more workers can perform a defined gesture when observing an anomaly. At block 1020, a system according to embodiments can collect and label sensor data, such as recent camera data, from certain regions with defined gestures when known reactions are detected. At block 1025, a machine learning model may be retrained with automatically collected and labeled training data of block 1020 in an interactive manner to obtain a well-adapted machine learning model.

Once the model is well trained, the model is ready to detect anomalies with both known and unknown reactions. At block 1030, the system collects and labels sensor data and/or machine data (e.g., PLC, SCADA, etc.) for a preceding time interval (e.g., past few minutes) in response to detected worker gestures. At block 1035, a data analysis or mother machine learning model may be run to fine repetitive patterns from collected data at block 1035. At block 1040, collected data from block 1035 may be used to train a machine learning model to predict repetitive patterns. Note the reaction of anomalies and the cause of anomalies are different. The reaction of an anomalies follows the occurrence of an anomaly. The cause of an anomaly occurs earlier than the anomaly and causes the anomaly to happen. In order to provide anomaly prevention, the cause of anomalies should be identified prior to occurrence. According to embodiments, with worker intelligence, data is collected before anomaly occurrence, and collected data for an anomaly may be labeled. According to embodiments, machine learning models are configured to find the repetitive patterns from sensed data to identify the cause and predict the cause. Note that the above mentioned worker gestures for transmitting alarm signals can also be other forms, such as acoustic data segments such that detection and handling may be similar to process steps for image data.

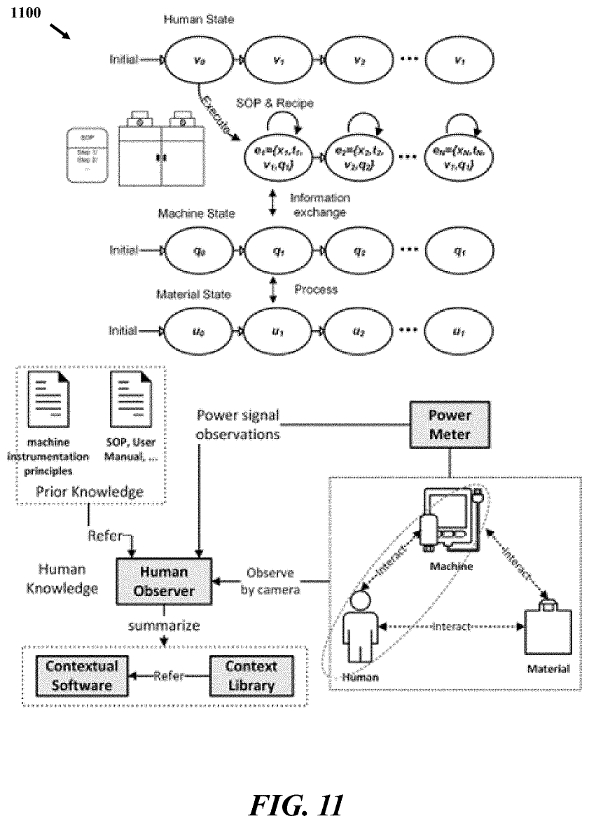

Embodiments herein can also provide a contextual sensor system for non-intrusive machine status and energy monitoring. FIG. 11 shows a contextual sensor system 1100 configured to utilize a finite state machine model (FSM) model including workers and machines and correlated through state transition function. The system hardware includes a visual camera and a power meter to collect real-time data, and a contextual software to process the sensed contents to generate contextual information. According to embodiments, the system implementation incorporates a knowledge transfer framework that leverages human knowledge and documented knowledge to initialize the contextual software design with two sensors. Experimental studies of embodiments have shown a semiconductor fabrication machine is successfully demonstrated using contextual sensor system hardware and software architecture.

According to embodiments, a context-centric standard operating procedure (SOP) model and knowledge transfer framework are provided. For a single manufacturing machine or workstation, the standard operation procedures (SOP) provided by equipment vendors define a sequence of operations a worker needs to accomplish which can be modeled. The interactive events define the actions or information a worker needs to take and the expected results a machine will provide, which forms a cause and effect pair. The contextual information underneath an event can be modeled to incorporate the location, timestamp and event properties for objects (e.g., workers and machines). The worker and machine states can be modeled as a Finite state machine (FSM) ley to represent the consistent state transition. The SOP provides state transition information as shown in FIG. 11. The machine or component states can be operation states, such as off, standby, on and material loaded, etc. The worker states can be operating actions (e.g., button press, movements, activation of controls, etc.). Operation states of a machine include multiple functional instrumentation modules, i.e., heating, pumping, spinning, etc., which are independently processed by various machine components and can operate in sequence or simultaneously. The machine states and worker states are correlated through a transition function. SOP events can include machine state change as a result of different worker states. For example, a manually controlled machine is turned on because a worker presses the switch. By using a correlated SOP model as the basis, machine events and worker events can be detected independently and correlated uniformly to uncover context. One application may include a machine energy state determination. In addition to the related worker and machine state transitions, materials can also change their states after a worker controls a machine to process. The material state transitions can be additive or subtractive to a part (e.g., wafer) to show shape change, phase change (e.g., metal refining from solid to liquid), or chemical reactions with byproducts.

According to embodiments a correlated SOP model serves as the basis of a knowledge transfer framework and sensor system. The correlated SOP model can define two entities to be measured, worker states and machine states. In order to capture signals from both sides, a visual camera (can be a security camera) and a power meter are selected as the hardware sensors for the contextual sensor systems. Visual Cameras contain meaningful contexts that directly capture workers and surroundings, which is selected to determine worker states and side channel information from the surrounding environments and machines. A machine or component energy state change can be directly reflected on the energy consumption, which may be measured by a main power meter in real time.

Based on the SOP model, a knowledge transfer framework is built to define a workflow to transfer the implicit engineering knowledge from workers and documented prior knowledge to initialize the system design loop as illustrated in FIG. 11. For example, a shop floor can include three major elements: people, machines, and materials, among which direct or indirect interactions occur to proceed the manufacturing processes in a way of state transition. For example, a machine interacts with materials to process a recipe (e.g., deposition, etching) for changing the product state. A worker interacts with a machine through an interface to control process parameters, start running processes, and change the machine state. After few iterations, a contextual sensor software can be developed to act as an artificial human observer to recognize component state transitions from aggregated power signals. According to embodiments, the knowledge of an observer can be abstracted and encoded into a context library where several known consequences of the interaction processes and events are stored, and which can be used as a look-up database to search for possible sources when some typical sequences of events are detected. Deviation of typical sequences of events could be used to identify anomalies of machine operation, which might be attributed to gradual performance degradation of functioning components or undetected intrusions in cyber-attacks. In addition, with many component state transitions being detected, the WMI videos can be annotated in a label-free manner according to the FSM-defined state transition correlation to train a ML model to recognize the interactions.

According to embodiments, a two-stage operation for data processing may be employed to aggregate raw power signals from machines. Power events may be classified as components requiring a steady power supply and components in a pulsating mode. One or more power filers may be used to selectively identify changes in power to machine components.

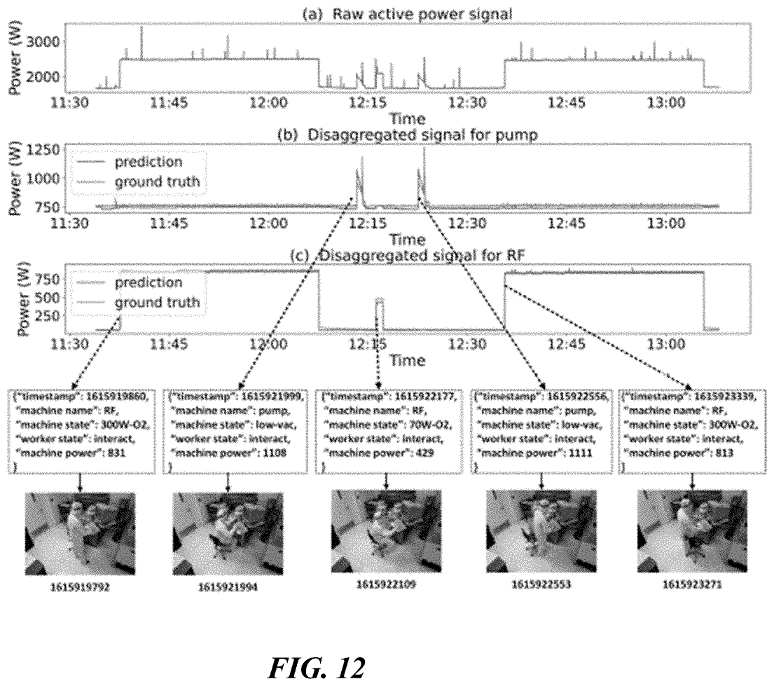

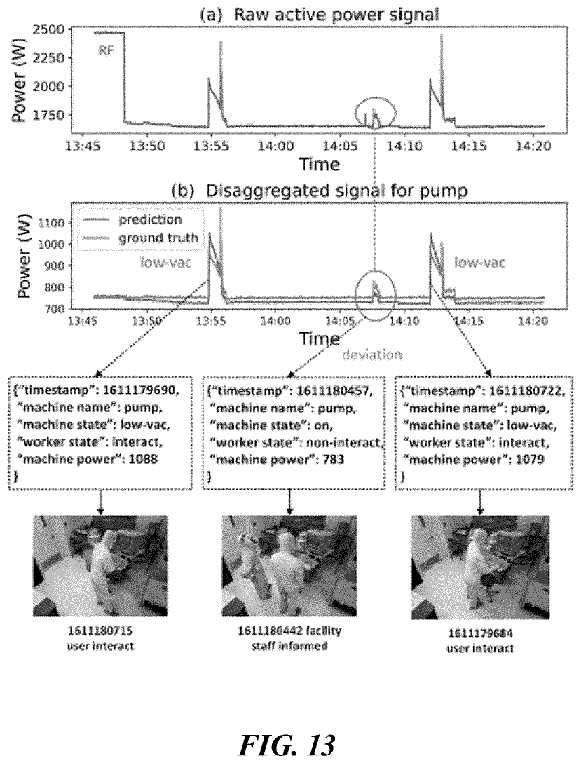

FIG. 12 illustrates exemplary power data and image data captured for a machine operation. As shown, power signals are plotted and events are identified. Extracted event context may be timestamps to video sensor data. FIG. 12 illustrates a first type of captured context during machine operation. The measured main power signal with disaggregated signals and ground truth signals are plotted. Positive edges in the power signal correspond to events, which may be indicative of a state change, with components from inactive mode to active modes. Extracted event contexts with a timestamp, machine (component) name, state and actual power, and worker state may be formulated. FIG. 13 also illustrates video image data that may be detected and correlated with power meter data based on timestamps. According to embodiments, sensor data, such as power signals and/or video data may be used to assess the machine operation. According to embodiments, video image data may also be processed to capture and label operator actions, such as body movements.

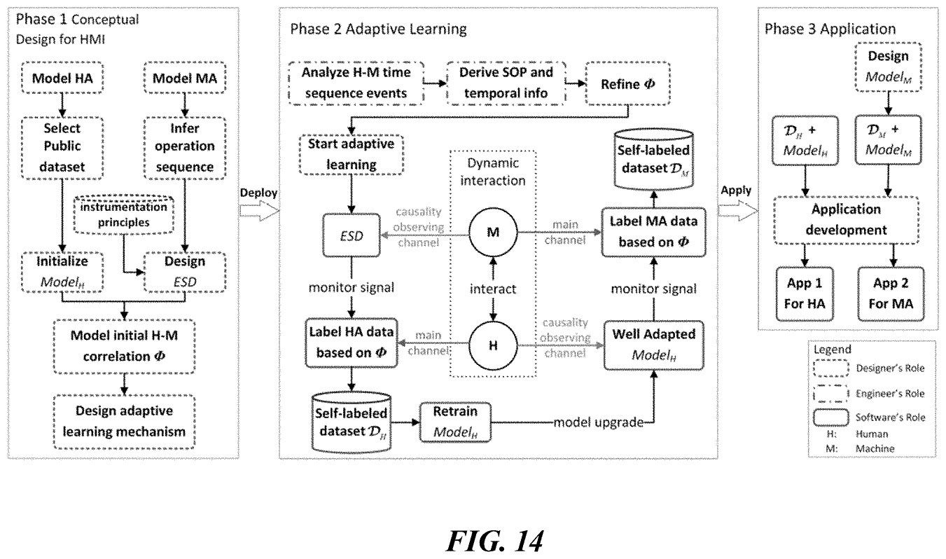

FIG. 13 illustrates context extraction between states of a machine operation (e.g., pumping states) including time states and illustrates a difference between predicted power usage and detected power data. In FIG. 13, between two pumping down (e.g., low-vac states), a small bump with actual power deviates from the average of pump on state. According to embodiments, the facility is informed during the anomaly occurrence and checks the machine status. From a display monitor a user can notice abnormal pressure values and inform the facility to indicate that the gas inside the chamber is not vacuumed to the expected pressure and the air tightness of the vacuum system is likely faulty. After a second time pumping down, the pressure becomes normal. The extracted context is saved in the database and can be used as a reference when the same event sequence is met. A significance of this captured context is to be used to conduct predictive maintenance and anomaly detection. Embodiments herein can also provide an interactive and adaptive learning cyber physical human system for manifesting in worker machine interactions. FIG. 14 shows a three phased approach for an interactive cyber physical human system (ICPHS) framework. An ICPHS framework may be based on scenarios of an interactive manufacturing work, wherein at least one worker and at least one machine is involved. The ICPHS framework may utilize causality-based self-labeling mechanism in a worker machine interaction scenario.

In FIG. 14, three phases are shown for ICPHS framework where phase 1 is a static conceptual design to develop Human-Machine Interaction (HMI) models, phase 2 is a deployment phase to acquire dynamic information from HMI to self-adapt ML models with minimum human intervention, and phase 3 is application development to align self-adapted models to opportunities for manufacturing predictive intelligence. According to embodiments, several types of human roles may be involved in the ICPHS to work collaboratively for a comprehensive evolving ICPHS, namely system designers who are data and computer scientists from data service providers, and onsite workers including operators, engineers and technicians from manufacturers. System designers undertake the tasks to design and implement the data service with adaptive learning software. Workers interact with machines to conduct equipment operations for production and provide necessary floor information for system designers.

Phase 1 of the ICPHS framework is to accomplish a static goal of data-driven management of any generic manufacturing equipment by using known information from machine and human experience before deploying sensors to acquire signals from machine and human. This ML design principle allows extended and scalable applications to various manufacturing fields. In a factory, workers generate human activities (HA) when interacting with machines to operate, inspect, or repair in the form of physical movements (e.g., hand, foot, body) and functional objectives (e.g., running recipe, developing SOP, troubleshooting). Based on such knowledge and machine manuals, possible HA gestures and orders are estimated by system designers and modeled in the form of logic state transition. An unformed HA state detector using a vision-based ML model Model_{H} with data from visual cameras is then built from selecting public dataset resembling estimated HA. Similarly, machines are composed of multiple functional components (e.g., heating, vacuum pumping, spindle) and generate machine activities (MA) induced by human interactions in the form of logic operation sequences and functional tasks. With machine manuals and basic engineering knowledge, MA are modeled as logic state transitions and the component operation sequence can be inferred. An unsupervised MA state detector such as energy state detector (ESD) with data from power meter, which can be regarded as a naive classifier for energy events, is built leveraging instrumentation principles of machine components. With HA and MA models as well as inferred operation sequence, an initial H-M correlation model Φ based on the temporal relationship and causality between HA and MA is built as the foundation of adaptive learning mechanism. For example, a machine component is turned active because of a worker's operation towards a control panel a few moments earlier. Such correlation can be used to design the data self-labeling mechanism to achieve label-free adaptive learning. When phase 1 completes, sensors and initial ML software are deployed at the manufacturing floor to proceed to phase 2.

In phase 2, real time video and power data are accessible through GUI to be analyzed. HMI time sequence events are analyzed by field engineers to derive SOP and temporal information for each machine. The analyzed information is transmitted to remote system designers to refine the model and start the automated adaptive learning. For matured manufacturing processes, prior developed SOP can be readily accessible at phase 1 to ease the design. The first 3 steps at phase 2 can be iterated several times to refine and evaluate the model. Refined adaptive learning software may tracking HA and MA and collect real time data. During dynamic HMI, information retrieval from two sides can be defined as main channel and causality observing channel, and their roles can exchange depending on tasks. A main channel is defined as the channel to optimize its performance through self-labeling. A causality observing channel is defined as the channel to validate events happened on the other side involved in HMI to generate monitor signals for annotating main channel data. Initially, the machine side is regarded as a causality observing channel to feed power signal of individual machine to its ESD to detect current component states (e.g., on/off) of a single machine. Based on model, the system knows mappings between machine state transitions and HA with temporal sequences and responses, which are leveraged to label the corresponding HA segment with the machine state transition information. After some duration of data self-labeling and collection, a self-labeled HA dataset DH is generated to retrain a model for better HA recognition accuracy. In addition, the self-labeling based on machine state transition can capture HA differences regarding various machine/component operation, enabling model upgrades to recognize more HA classes with more fine-grained DH. After several rounds of adaptive retraining, a well-adapted model is established. Note that this downward branch for optimizing a model can be accomplished several times independently for multiple machines. Similarly, the well-adapted model can serve as the causality observing channel estimator to annotate the main channel MA as the model is able to recognize individual HA for operating a specific machine component. As a result, a self-labeled MA dataset DM is established.

In phase 3, applications aligned to manufacturer interests can be designed with self-labeled datasets and ML models on behalf of human and machine. ML models, such as Model_{M} or advanced Model_{H}, can be designed or redesigned based on applications.

Different from human daily activities, manufacturing worker activities generally follow assigned task schedules and machine operation manuals or procedures (i.e., SOP), which constrain the degree of freedom of HA and MA and thus ease model designs. For operating a machine, SOP defines a sequence of HA to follow, resulting in a sequence of MA. The SOP is modeled as a series of events, where each event contains information about location, time, worker state, and machine state. Finite state machines (FSM) models are used to model HA and MA as states and their collaborative state transition free adaptive learning for manufacturing ML applications is explored by leveraging the underlying correlation between machine and human state transitions. Based on experimental results, the ICPHS demonstrates that at initialization design phase it can recognize the worker machine interaction with public dataset, and that during deploy phase it can self-adapt to manufacturing environment via retraining ML model utilizing dataset automatically collected and labeled by the system based on the HMI correlation model. Moreover, experimental results demonstrate potential to achieve automated class incremental learning with the self-labeled dataset to identify more interaction classes.

According to embodiments, SOP can define states for normal machine operations and worker actions in controlling machines but it excludes unknown anomalous states. Embodiments to identify unknown states can include a correlation model, with a worker viewed as a mobile sensor with an information processing unit to facilitate intelligent feedback from interactions on demand for production evaluation. In addition, unsupervised clustering methods can analyze data feature similarity among the self-labeled data deviating from SOP domain to identify anomaly. Other fields where a SOP-like manual is available and main and causality observing channel information are accessible, the proposed ICPHS framework could be applied.

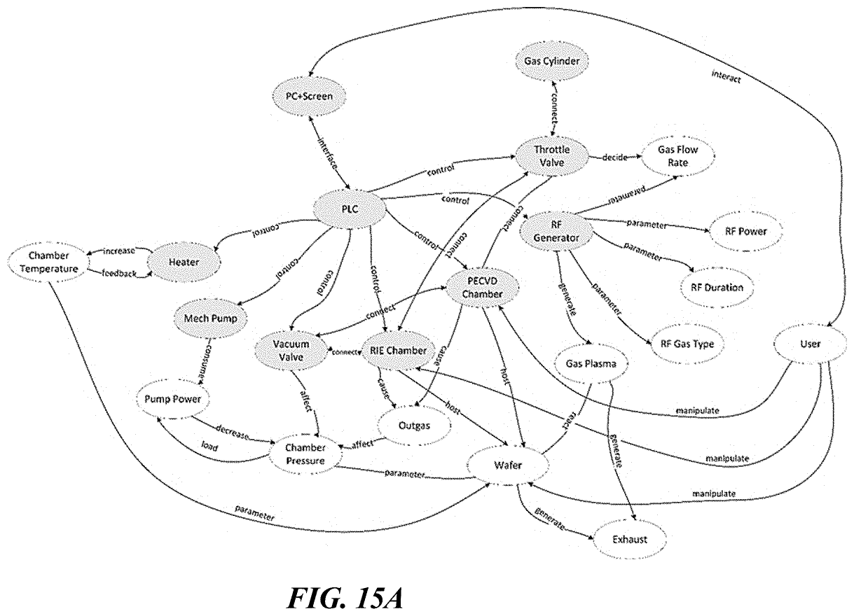

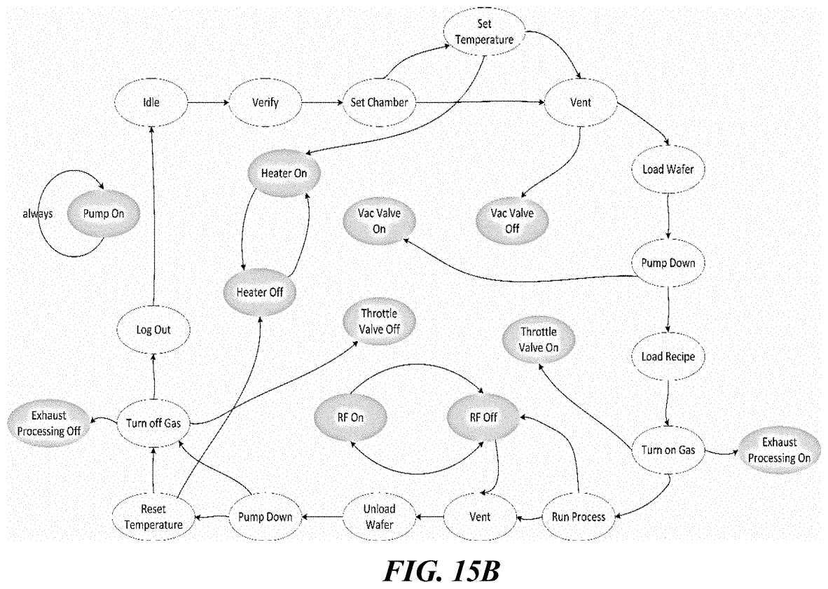

FIG. 15A illustrates an example of a static ontology model of a machine used for semiconductor reactive ion etching and chemical vapor deposition according to one or more embodiments. According to embodiments, manufacturing domain knowledge referred to in this disclosure may be modeled in an ontology model. The ontology model may define entities, properties of entities, and relationships between entities. The ontology model may be static and not contain temporal information. For example, the domain knowledge of a chemical vapor deposition (CVD) machine may be expressed in an ontology model with its components, control logic, capabilities, attributes, and their relationships. With the ontology model describing static relationships among entities, a standard operating procedure (SOP) can be developed for a specific machine and for a specific recipe in processing materials. The SOP may include dynamic information about when to operate which component for the purpose of accomplishing a specific task or process. According to embodiments, dynamic information may be represented as a dynamic knowledge graph including sequential or parallel steps of state transitions.

FIG. 15B illustrates a dynamic knowledge graph converted from SOP of a machine for the static ontology model of FIG. 15A according to one or more embodiments. In the dynamic knowledge graph, the link between nodes represents their relative sequential relations and may be associated with a time interval representing the time lag between the dynamic events in linked nodes. A causality model can be established based on the domain knowledge represented in the format of dynamic knowledge graph and can be used for the purpose of self-labeling of machine generated data (i.e., adaptive machine learning at field deployment) to extract contextual information in real world applications leading to actionable intelligence for supporting decision making by users.

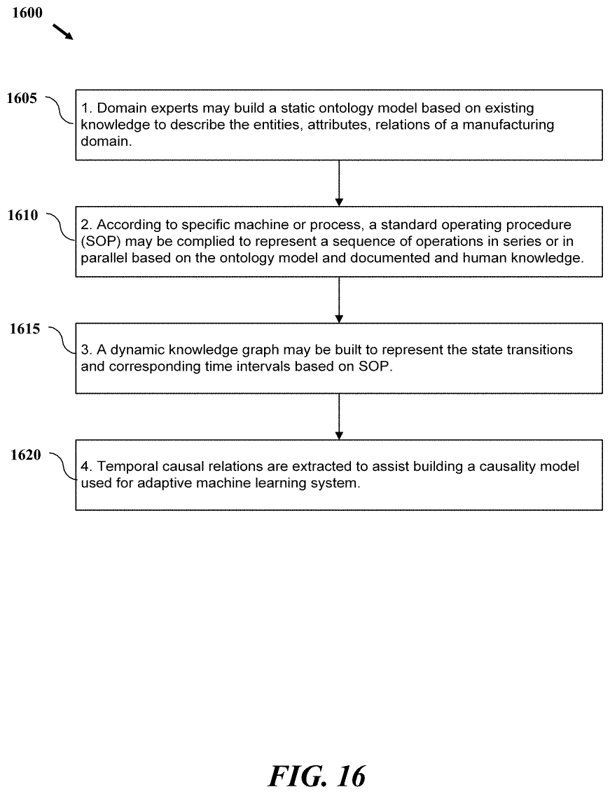

FIG. 16 illustrates process 1600 for extracting causal relations from existing knowledge using ontology and dynamic knowledge graph representation according to one or more embodiments. Process 1600 may allow for development of ontology and a dynamic knowledge graph from existing knowledge to assist building a causality model. At block 1605 (e.g., step 1), domain experts, such as local technicians and equipment vendors/engineers, may develop or provide a graphical representation of an ontology model with the static functions, attributes, relationships of a machine. At block 1610 (e.g., step 2), referring to the built ontology, machine manuals, and expert knowledge, a standard operating procedure representing a sequence of operation in series or in parallel for a machine or a process may be built. At block 1615 (e.g., step 3), the built SOP may be represented as a dynamic knowledge graph showing the state transitions and corresponding time intervals. At block 1620 (e.g., step 4), temporal causal relationships may be extracted from the dynamic knowledge graph derived from block 1615 to build a causality model for the adaptive machine learning system.

While this disclosure has been particularly shown and described with references to exemplary embodiments thereof, it will be understood by those skilled in the art that various changes in form and details may be made therein without departing from the scope of the claimed embodiments.

What is claimed is:

1. An auxiliary advising system to monitor machine operation, the system comprising:
a first sensor configured to detect a state of a first object of the machine operation;
a second sensor configured to detect a state of a second object of the machine operation;
a controller coupled to the first sensor and the second sensor, wherein the controller is configured to
receive the state of the first object and the state of the second object,
assess the machine operation using a causality model for at least one of the first object and second object, wherein the causality model includes a labeled dataset for machine operation, and
output a machine operation determination including at least one of a context adaptation output, interaction context detection output and anomaly prevention output.

2. The system of claim 1, wherein the first sensor and the second sensor detect operations of the first object and the second object, wherein the state of the first object and the state of the second object are each finite states of a finite state machine model for the machine operation.

3. The system of claim 1, wherein the first sensor is a camera sensor and the second sensor detects power usage of at least one component of the machine operation.

4. The system of claim 1, wherein the causality model of the machine operation is determined using a model for each of the first object and the second object, and wherein the labeled dataset identifies interactions of objects and sensor output.

5. The system of claim 1, wherein the causality model provides a model for interactions between the first object and the second object, wherein the causality model includes at least one data segment labeled based on a causal state transition for at least one of the first object and second object.

6. The system of claim 1, wherein machine operation is assessed using a trained dataset for interactions between the first object and the second object, the trained dataset generated for the machine operation by mapping sensed data to standard operating procedure of at least one machine component.

7. The system of claim 1, wherein the context adaptation output provides a determination for sensed data compared to historical data for the machine operation to include at least one of an alert of a data shift, deviation from data pattern, and change in environmental condition.

8. The system of claim 1, wherein the interaction context detection output provides a determination of at least one causal interaction between the first object and second object and a determination of a source of an interaction.

9. The system of claim 1 wherein the anomaly prevention output labels at least a portion of collected data for the machine operation as an anomaly.

10. The system of claim 1, wherein outputting a machine operation determination includes annotating sensor data of a first object to include a label in response to detection of a state transition in at least one data segment for the second object.

11. A method for operation of an auxiliary advising system to monitor machine operation, the method comprising:
receiving, by a controller, output from a first sensor configured to detect a state of a first object of the machine operation, and output from a second sensor configured to detect a state of a second object of the machine operation;
assessing, by the controller, the machine operation using a causality model for at least one of the first object and second object, wherein the causality model includes a labeled dataset for machine operation; and
outputting, by the controller, a machine operation determination including at least one of a context adaptation output, interaction context detection output and anomaly prevention output.

12. The method of claim 11, wherein the first sensor and the second sensor detect operations of the first object and the second object, wherein the state of the first object and the state of the second object are each finite states of a finite state machine model for the machine operation.

13. The method of claim 11, wherein the first sensor is a camera sensor and the second sensor detects power usage of at least one component of the machine operation.

14. The method of claim 11, wherein the causality model of the machine operation is determined using a model for each of the first object and the second object, and wherein the labeled dataset identifies interactions of objects and sensor output.

15. The method of claim 11, wherein the causality model provides a model for interactions between the first object and the second object, wherein the causality model includes at least one data segment labeled based on a causal state transition for at least one of the first object and second object.

16. The method of claim 11, wherein machine operation is assessed using a trained dataset for interactions between the first object and the second object, the trained dataset generated for the machine operation by mapping sensed data to standard operating procedure of at least one machine component.

17. The method of claim 11, wherein the context adaptation output provides a determination for sensed data compared to historical data for the machine operation to include at least one of an alert of a data shift, deviation from data pattern and change in environmental condition.

18. The method of claim 11, wherein the interaction context detection output provides a determination of at least one causal interaction between the first object and second object and a determination of a source of an interaction.

19. The method of claim 11, wherein the anomaly prevention output labels at least a portion of collected data for the machine operation as an anomaly.

20. The method of claim 11, wherein outputting a machine operation determination includes annotating sensor data of a first object to include a label in response to detection of a state transition in at least one data segment for the second object.

21. A method for determining labeled datasets for operation of an auxiliary advising system to monitor machine operation, the method comprising:
receiving, by a controller, a plurality of defined first object states and a plurality of defined second object states;
receiving, by a controller, domain data for the first object and the second object, the domain data including a standard operating procedure for the first object and the second object in a machine operation;
determining, by the controller, a causality model for the first object and the second object, wherein the causality model maps detected object states to at least one causal state;
labeling, by a controller, at least one data segment of sensor data for at least one of the first object and the second object; and
generating, by the controller, the causality model for a machine operation to include evaluations for at least one of context adaptation, interaction context detection and anomaly prevention.

22. The method of claim 21, wherein the first object is one of a machine, worker and material, and the machine operation includes at least one interaction between the first object and the second object.

23. The method of claim 21, wherein the causality model of the machine operation is determined using a model for each of the first object and the second object, and wherein labeling data identifies interactions of objects and sensor output.

24. The method of claim 21, wherein labeling at least one data segment of sensor data includes identifying at least one state transition for an object, selection of the at least one data segment based on a temporal relationship of the at least one state transition, and annotating the at least one data segment with a label.

25. The method of claim 21, wherein labeling at least one data segment of sensor data for at least one of the first object and the second object includes identifying a time interval between a state transition for the first object and a state transition for the second object, and annotating at least one segment of data of an identified state transition with information identifying the state transition.

26. The method of claim 21, wherein the context adaptation provides a determination for sensed data compared to historical data for the machine operation to include at least one of an alert of a data shift, deviation from data pattern and change in environmental condition.

27. The method of claim 21, wherein the interaction context detection provides a determination of at least one causal interaction between the first object and second object and a determination of a source of an interaction.

28. The method of claim 21, wherein the anomaly prevention labels at least a portion of collected data for the machine operation as an anomaly.

29. The method of claim 21, wherein the causality model provides a model for interactions between the first object and the second object, wherein the causality model includes at least one data segment labeled based on a causal state transition for at least one of the first object and second object.

30. The method of claim 21, further comprising representing a standard operating procedure as a dynamic knowledge graph showing state transitions and corresponding time intervals, and extracting at least one temporal causal relationship from the dynamic knowledge graph to build the causality model.
